(19) United States
(12) Patent Application Publication
(10) Pub. No.: US 2025/0169623 A1
(43) Pub. Date: May 29, 2025

(54) FOOD DISPENSING MACHINE INCLUDING A TRAY AND AN AUGER FOR A FOOD DISPENSING MACHINE

(71) Applicant: Gold Medal Products Co., Cincinnati, OH (US)

(72) Inventor: Todd M. Kroeger, West Chester, OH (US)

(21) Appl. No.: 18/958,235

(22) Filed: Nov. 25, 2024

Related U.S. Application Data
(60) Provisional application No. 63/602,783, filed on Nov. 27, 2023.

(51) Int. Cl. A47F 1/03; G07F 9/10; G07F 11/24

(52) U.S. Cl. CPC A47F 1/03; G07F 9/10; G07F 11/24

(57) ABSTRACT

A food dispensing machine includes a tray, an auger, and a motor. The housing defines an interior and includes a front wall that defines a dispensation opening adjacent to the interior. The tray is disposed in the interior and defines a trough that is disposed adjacent to the dispensation opening. The auger is disposed in the trough and is selectively rotatable about a rotational axis. The motor is operably coupled with the auger for powering rotation of the auger.

### REFERENCE TO RELATED APPLICATION

This application claims priority of U.S. provisional patent application Ser. No. 63/602,783, entitled Food Dispensing Machine Including a Tray and an Auger for a Food Dispensing Machine, filed Nov. 27, 2023, and hereby incorporates this application by reference herein in its entirety.

### TECHNICAL FIELD

Embodiments of the technology relate, in general, to food dispensing machines and a tray and auger for the food dispensing machines.

### BACKGROUND

Automated food dispensing machines allow for the delivery of a ready to eat food product, such as popcorn, to a consumer. These automated food dispensing machines typically include a sloped tray and an auger disposed at the bottom of the tray. The food product is provided onto the sloped tray and the auger rotates to deliver a serving size of the food product from the tray to a consumer. The sloped tray is sloped towards the auger to effectively funnel the bulk food product towards the auger such that, as the auger rotates, more of the food product is introduced towards the auger until the tray is empty. In some instances, some of the food product can become lodged on the tray adjacent to the auger and thus might not get funneled to the auger due to the configuration of the tray and/or the shape and size of the food product. In these instances, human intervention is often necessary to dislodge the food product from the tray, such as by shaking the automated food dispensing machine or by manually disturbing the remaining food product, which can increase the risk of damage to the machine and/or the risk of unsanitary handling of the food product.

### BRIEF DESCRIPTION OF THE DRAWINGS

FIG. 1 is a front lower perspective view depicting a food dispensing machine;

FIG. 2 is a rear upper perspective view of the food dispensing machine of FIG. 1 depicting a tray and an auger in association with the tray, the tray including a main structure;

FIG. 3 is a cross sectional view taken along the line 3-3 of FIG. 2 depicting a motor in association with the auger of FIG. 2;

FIG. 4 is an exploded view of the motor and auger of FIG. 3;

FIG. 5 is an exploded view of the tray of FIG. 1;

FIG. 6 is a front view of the main structure of the tray of FIG. 1;

FIG. 7 is an assembled front perspective view of the tray depicted in FIG. 1;

FIG. 8 is a cross-sectional view taken along the line 8-8 of FIG. 1;

FIG. 9 is an enlarged view depicting the encircled portion of FIG. 8; and

FIG. 10 is a cross-sectional view taken along the line 10-10 of FIG. 1.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

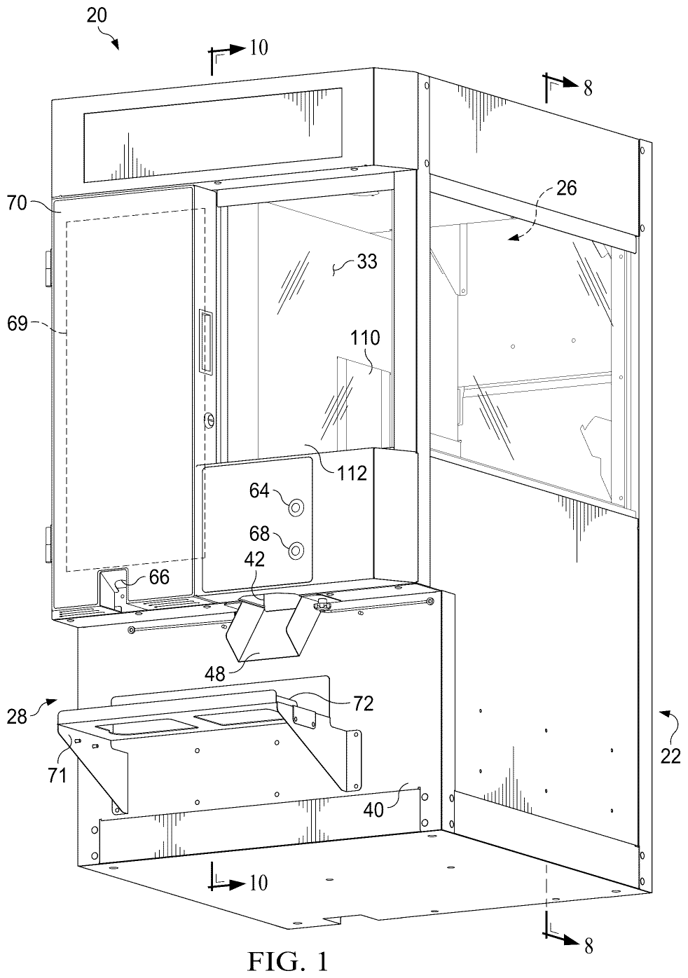

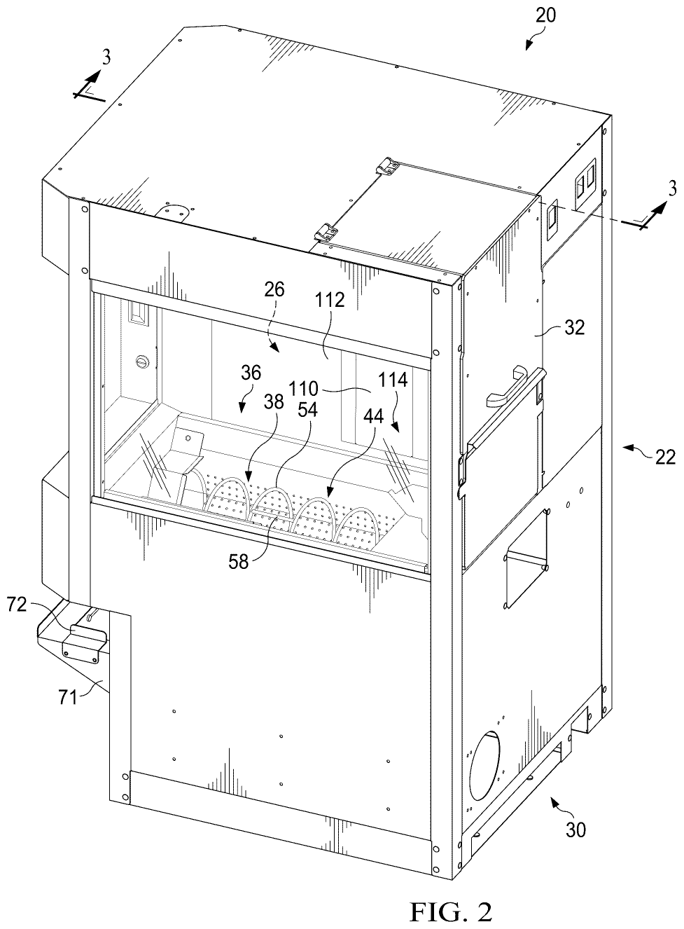

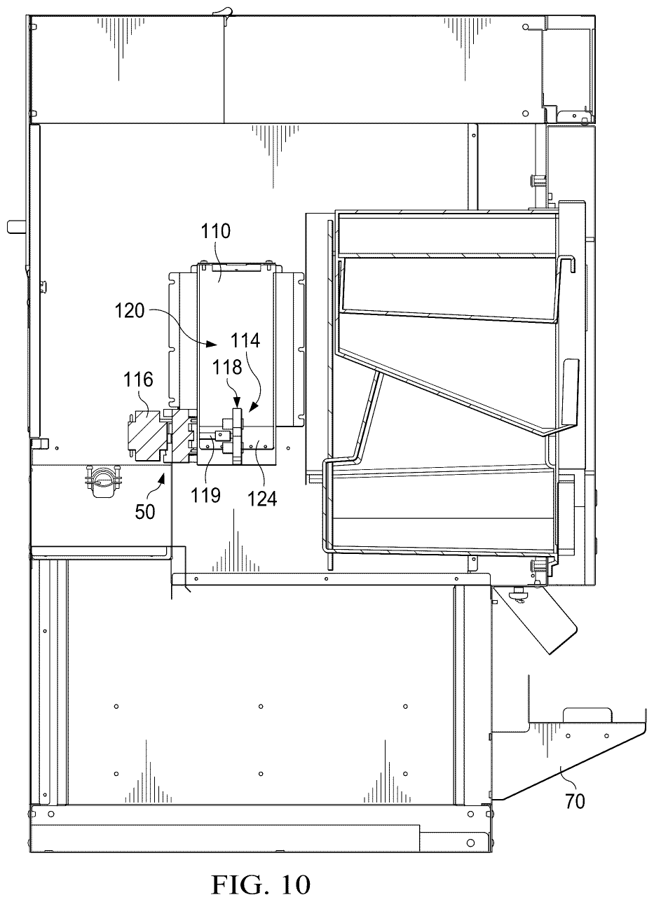

Embodiments are hereinafter described in detail in connection with the views and examples of FIGS. 1-10, wherein like numbers indicate the same or corresponding elements throughout the views. A food dispensing machine 20 that facilitates dispensation of a consumable chip to a consumer, such as a nacho chip, is generally depicted in FIGS. 1 and 2. Although the food dispensing machine 20 is described herein for use with nacho chips, any of a variety of suitable alternative chip types, such as potato chips, or other types of bulk food products, such as, for example, popcorn, pretzels, and crackers are contemplated for use with the food dispensing machine 20. The food dispensing machine 20 can be a free-standing unit having a housing 22 that is supported by a plurality of legs (not shown) that can each be selectively adjustable for stable positioning on a counter, table top, or floor, for example, or alternatively can be associated with a support base (not shown) that sits on a floor for supporting the food dispensing machine 20. In some embodiments, the support base can include a waste basket and/or a catch basin to catch product that is dispensed from the food dispensing machine 20.

The housing 22 includes an interior chamber 26 (FIG. 2), a front side 28 (FIG. 1), and a rear side 30 (FIG. 2). As illustrated in FIG. 2, a door 32 can be disposed along the rear side 30 and can be selectively opened to gain access to the interior chamber 26. A plurality of windows (e.g., 33 in FIG. 1) can be provided along the remaining sides of the housing 22 to allow for easy viewing into the interior chamber 26 while simultaneously preventing access thereto. In an alternative embodiment, a pair of doors (e.g., 32) can be provided on any of the other sides of the housing 22 (e.g., the front side 28). A tray 36 can be disposed within the interior chamber 26 and can define a trough 38 that serves as a collection area for the chips.

As illustrated in FIG. 1, a front wall 40 of the housing 22 can define a dispensation opening 42 that is disposed adjacent to the trough 38. An auger 44 (FIG. 2) can be disposed in the trough 38 and can be selectively rotated to dispense chips out of the dispensation opening 42 and to a consumer at the front of the food dispensing machine 20. A chute 48 can be disposed beneath the dispensation opening 42 to facilitate routing of the chips from the dispensation opening 42 into a serving container, or other type of container, that is positioned beneath the dispensation opening 42.

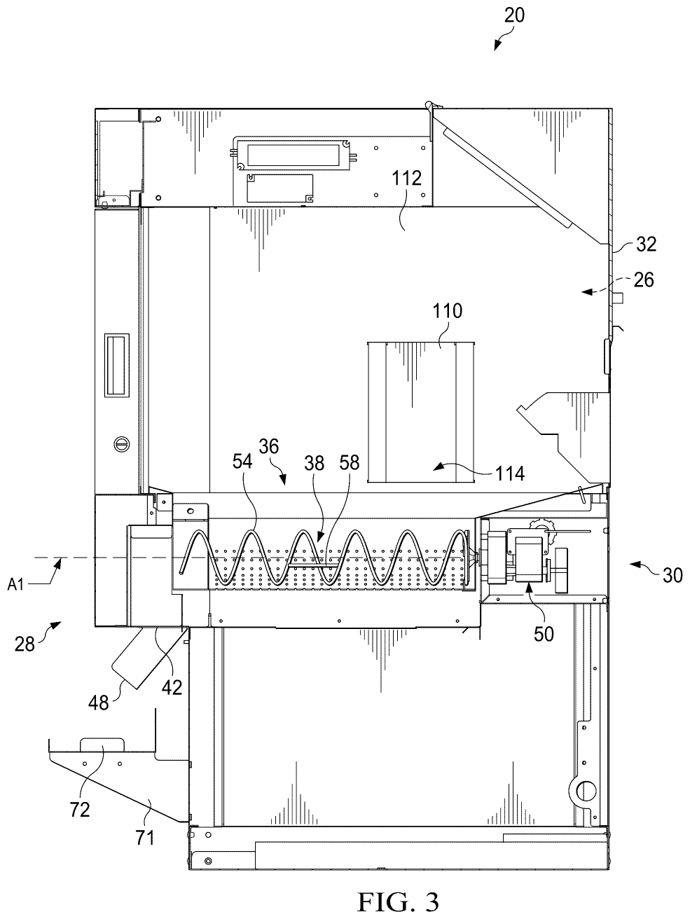

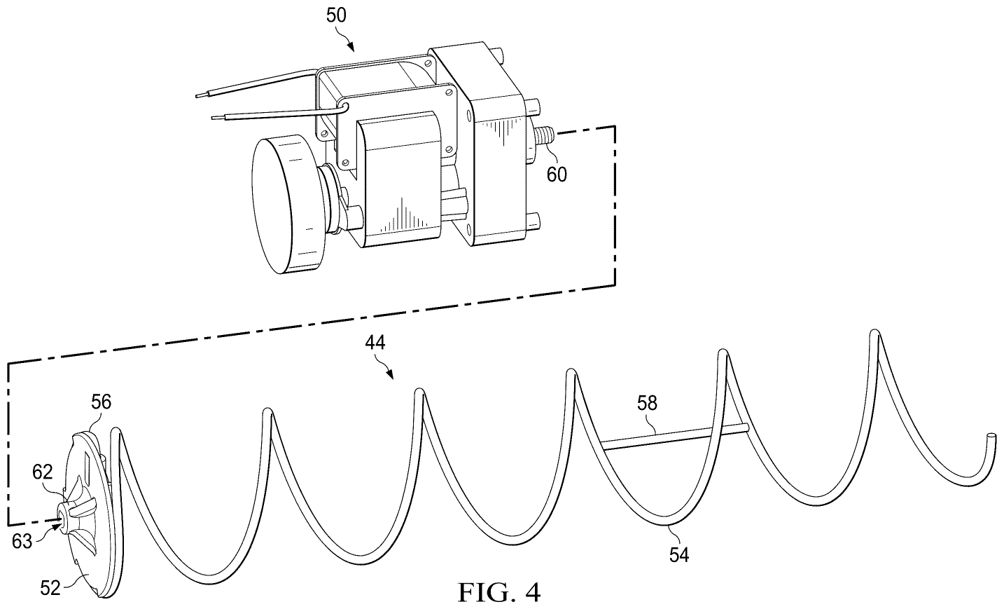

Referring now to FIGS. 3 and 4, a motor 50 can be operably coupled with the auger 44 for powering the rotation of the auger 44 about a rotational axis A1 (FIG. 3). The auger 44 can include a coupling base 52 and a helical coil member 54. The helical coil member 54 can be coupled to the coupling base 52 with retention features 56 of the coupling base 52. In one embodiment, the coupling base 52 can be formed of a thermoplastic, and the helical coil member 54 can be formed of stainless steel, but it is to be appreciated that any of a variety of suitable materials are contemplated.

The helical coil member 54 can be formed of a continuous wire element that is wound circumferentially about the axis A1 (e.g., in a substantially cylindrical helix arrangement). A cross member 58 can be coupled with the helical coil member 54 at two different locations along the length (e.g., between adjacent longitudinal portions) of the helical coil member 54. In one embodiment, as illustrated in FIG. 4, the cross member 58 can be substantially parallel with the rotational axis A1. It is to be appreciated however that other orientations of the cross member are contemplated. During rotation of the auger 44, the cross member 58 can rotate circumferentially about the rotational axis A1 to repeatedly contact the pile of chips and encourage them towards the dispensation opening 42. In other words, the cross member 58 can sweep along the circumference of the helical coil member 54 to agitate the chips surrounding the helical coil member 54. This agitation can continuously encourage the chips into interaction with the helical coil member 54 to prevent the chips from stalling and becoming stuck thus encouraging consistent dispensation of the chips towards the dispensation opening 42.

As illustrated in FIG. 4, the motor 50 can include a threaded driveshaft 60 that is operable to rotate when the motor 50 is activated. The threaded driveshaft 60 can be threadedly coupled with the auger 44 to facilitate rotation of the auger 44 in a dispensation direction (e.g., a rotational direction that facilitates dispensation of chips through the dispensation opening 42). The coupling base 52 of the auger 44 can have a collar 62 that defines a central opening 63 that is aligned with the rotational axis A1. The collar 62 can have internal threads that interface with the threaded driveshaft 60 to facilitate threaded coupling therebetween. As such, the auger 44 can be threaded onto the threaded driveshaft 60 to securely join the auger 44 to the threaded driveshaft 60 for operation together.

The direction of the complimentary threads (e.g., right handed or left handed) on the threaded driveshaft 60 and the collar 62 can be selected such that rotation of the threaded driveshaft 60 in the dispensation direction facilitates threading of the auger 44 onto the threaded driveshaft 60 to ensure that the auger 44 and the threaded driveshaft 60 remain coupled together during operation. In one embodiment, the complimentary threads can be right-handed and the threaded driveshaft 60 can rotate in a counter-clockwise dispensation direction (as viewed from the front wall 40). In another embodiment, the complimentary threads can be left-handed and the threaded driveshaft 60 can rotate in a clockwise dispensation direction (as viewed from the front wall 40). In this manner, the threaded driveshaft 60 can be rotated in a direction that effectively tightens the coupling base 52 onto the threaded driveshaft 60. The threaded interface between the coupling base 52 and the threaded driveshaft 60 can prevent inadvertent decoupling of the coupling base 52 (and thus the auger 44) from the threaded driveshaft 60 during operation and can also allow the auger 44 to be easily removed (i.e., for cleaning) by simply rotating the auger 44 in an opposite direction as the dispensation direction. The threaded interface can accordingly provide a more dependable attachment between the coupling base 52 and the threaded driveshaft 60 that is easier to remove than conventional arrangements that utilize a shaped shaft (i.e., a D-shaped shaft) that is inserted into a complementary shaped opening on the coupling base. In one embodiment, the motor 50 can be an electric motor (e.g., an AC or DC motor) that only rotates in one direction (e.g., a one-way motor), but other motors are contemplated. Power for the motor 50 (and other electrical components) can be provided from a power cord (not shown) that can be plugged into a suitable power source, such as a wall outlet.

Referring again to FIG. 1, a first pushbutton 64 (FIG. 1) can be located on the front wall 40 of the housing 22 and can be electrically coupled with the motor 50 to facilitate activation of the motor 50. When a consumer wants chips to be dispensed from the food dispensing machine 20, the consumer can place a container beneath the chute 48. The consumer can then press the first pushbutton 64, which can cause the motor 50 to be activated in order to dispense chips from the dispensation opening 42 and onto the serving tray. In a commercial setting where a consumer prepays for a serving of chips, the motor 50 can be preprogrammed to operate for a predefined time after the first pushbutton 64 is depressed to ensure that a specific serving size is dispensed to the consumer. In a non-commercial setting, the motor 50 can be preprogrammed to operate while the first pushbutton 64 is depressed to allow the consumer to select the serving size of chips that are dispensed to the consumer.

The rotational speed of the motor 50 (and thus the auger 44) can be tailored to encourage the chips from the tray 36 into the auger 44 and through the dispensation opening 42 at a desired dispensation rate. In one embodiment, the motor 50 can be a single speed DC motor, or the like, which is configured to operate at a constant speed capable of dispensing the chips at the desired dispensation rate. In such an embodiment, the speed of the motor 50 and thus the dispensation rate can be selected to alleviate clogging or stalling of chips at the auger 44. In some instances, the motor 50 can be associated with a gearbox (not shown) that has a gear ratio that achieves a desired auger speed. In another embodiment, the motor 50 can be a variable speed DC motor, or the like, that is configured to operate at different speeds in real time in order to accommodate for different amounts of chips that are present at the auger 44 while maintaining a substantially consistent dispensation rate. For example, when a larger volume of chips is present on the tray, the motor 50 and thus the auger 44 can be rotated at a faster speed than when a smaller amount is present. Varying the speed of the motor 50 in this manner can prevent the dispensation rate of the chips from drastically changing as the volume of chips changes as is common in conventional food dispensers. The speed of the motor 50 can also be varied to correct any anomalies that might occur during dispensation. For example, if the chips become inadvertently clogged or stalled in the auger 44, the motor 50 can be configured to briefly oscillate the rotation of the auger (e.g., shudder the auger 44), or reverse the rotation of the auger 44 entirely for a brief period of time (e.g., 2 seconds), to encourage additional chips to fall into the auger 44.

Still referring to FIG. 1, the food dispensing machine 20 can include a spout 66 that is configured to dispense a topping, such as, for example, nacho cheese, salsa, or chopped jalapenos, therefrom and onto a consumer's tray. The spout 66 can be located adjacent to the chute 48 to allow a consumer to easily position their tray beneath the spout 66 after receiving the chips to facilitate dispensation of the topping onto the same tray. A second pushbutton 68 (FIG. 1) can be located on the front wall 40 of the housing 22 adjacent to the first pushbutton 64 and can be electrically coupled with the spout 66 to facilitate activation thereof. When a consumer wants a topping to be dispensed from the food dispensing machine 20, the consumer can place the serving tray beneath the spout 66 and can press the second pushbutton 68, which can cause the spout 66 to dispense the topping onto the serving tray. In a commercial setting where a consumer prepays for a serving of chips, the spout 66 can be preprogrammed to operate for a predefined time after the second pushbutton 68 is depressed to ensure that a specific serving size is dispensed to the consumer. In a non-commercial setting, the spout 66 can be programmed to operate while the second pushbutton 68 is depressed to allow the consumer to select the serving size of topping that is dispensed from the spout 66.

The food dispensing machine 20 can be configured to offer different types of toppings to a consumer that can be dispensed from the spout 66 from different containers. The food dispensing machine 20 can include a storage compartment 69 that is disposed adjacent to the interior chamber 26 and above the spout 66 and that is configured to store the different containers of toppings. The storage compartment 69 can be covered by a door 70 that provides access to the storage compartment. Each of the containers of toppings can be in fluid communication with the spout 66 via a valve system (not shown) that allows for different ones of the toppings to be selected for dispensation from the spout 66 via a digital interface (not shown). As such, when a particular topping is selected from among the available toppings in the containers, the selected topping is dispensed from the spout 66 when the second pushbutton 68 is depressed. In an alternative embodiment, the food dispensing machine 20 might only offer a single topping to the consumer in which case a single container, or multiple containers of the same topping, can be in stored in the storage compartment 69 and can be in fluid communication with the spout 66.

The food dispensing machine 20 is shown to include a tray holder 71 that is disposed at the front wall 40 and extends outwardly therefrom to support a serving tray. In one embodiment, the tray holder 71 can include stops 72 disposed at opposing ends to ensure proper alignment of the serving tray beneath either the chute 48 or the spout 66. In other words, sliding the serving tray against either the rightmost stop or the leftmost stop can align the serving tray under the chute 48 or the spout 66, respectively. In another embodiment, the tray holder 71 can be configured to automatically convey the serving tray from beneath the dispensation opening 42 after the chips are dispensed to the serving tray and to the spout 66 where the topping is dispensed onto the chips. In such an embodiment, the tray holder 71 can include any of a variety of automated conveyance systems, such as a conveyor belt or opposing solenoids, that facilitate indexing of the serving tray from the dispensation opening 42 to the spout 66. The conveyance of the serving tray from the dispensation opening 42 to the spout 66 can be fully automated such that, when the serving tray is placed on the tray holder 71 beneath the dispensation opening 42, the food dispensing machine 20 can recognize the presence of the serving tray (via proximity sensors (not shown)) and can automatically dispense chips thereto without requiring the consumer to utilize the first pushbutton 64. Once the chips have been properly dispensed onto the serving tray, the conveyance system can move the serving tray beneath the spout 66 which is then automatically activated to dispense the topping onto the chips without requiring the consumer to utilize the second pushbutton 68. In an alternative arrangement, the conveyance system can be controlled in response to activation of the first and second pushbuttons 64, 68. In such an arrangement, when the consumer places the serving tray onto the tray holder 71 and presses the first pushbutton 64, the chips can be dispensed onto the serving tray. The conveyance system can then automatically move the serving tray beneath the spout 66 at which point the consumer can push the second pushbutton 68 to cause the topping to be dispensed from the spout 66 onto the chips.

When the food dispensing machine 20 is provided in a commercial application, such as at a sporting event or in a business, the consumer can first be required to submit payment via a point of sale device (not shown) such as a credit card reader or bill acceptor. Once the required payment has been submitted and accepted, the first pushbutton 64 can illuminate to indicate to the consumer that the food dispensing machine 20 is ready to dispense chips from the dispensation opening 42. The point of sale device, or other display on the food dispensing machine 20, might also display a message with instructions on the placement of the serving tray beneath the dispensation opening and/or how to dispense chips by pressing the first pushbutton 64. When the consumer presses the first pushbutton 64, the motor 50 can be activated for a predetermined amount of time which rotates the auger 44 to dispense a particular serving of chips from the dispensation opening 42 into the serving tray. The serving size of chips that is dispensed can be a function of the amount of time that the motor 50 is activated and can thus be selected to control the serving size. In some embodiments, the consumer can select from among different serving sizes when submitting payment and the motor 50 can be activated for a duration that enables the selected serving size to be dispensed from the dispensation opening 42. Once the serving size of chips has been dispensed from the dispensation opening 42, the second pushbutton 68 can illuminate to indicate to the consumer that the food dispensing machine 20 is ready to dispense the topping. The point of sale device, or other display on the food dispensing machine 20, might also display a message with instructions to move the serving tray beneath the spout 66 and/or how to dispense the topping by pressing the second pushbutton 68. When the serving tray is moved beneath the spout 66 and the consumer presses the second pushbutton 68, the spout 66 can be activated to dispense the topping therefrom and onto the serving tray. The amount of topping that is dispensed from the spout 66 can be a function of the duration that the spout 66 is activated and can thus be selected to control the amount of topping therefrom. In embodiments where the food dispensing machine 20 provides different toppings, the consumer can use the point of sale device or other interface to select from among the different toppings and the spout 66 can be activated accordingly to enable the different selected topping(s) and/or amounts to be dispensed therefrom.

It is to be appreciated that when the food dispensing machine 20 is installed in a non-commercial setting, such as for personal use or as a novelty attraction, the food dispensing machine 20 might not require payment prior to dispensing the chips and the topping. In some embodiments, the amount of chips and toppings that are dispensed from the food dispensing machine 20 can still be controlled in a similar manner as described above. However, in other embodiments, the food dispensing machine 20 can be configured to dispense chips and toppings for as long as the first pushbutton 64 and the second pushbutton 68, respectively, are depressed. In these embodiments, the consumer is able to control the serving size of the chips and the amount of topping dispensed in real time as a function of the duration that the first pushbutton 64 and the second pushbutton 68, respectively, are depressed.

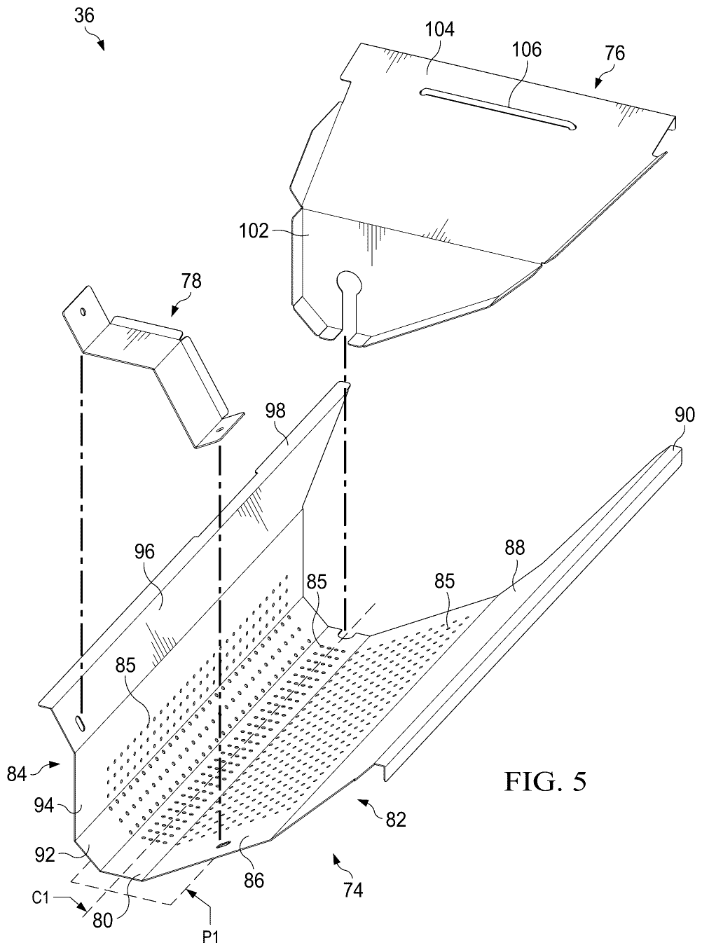

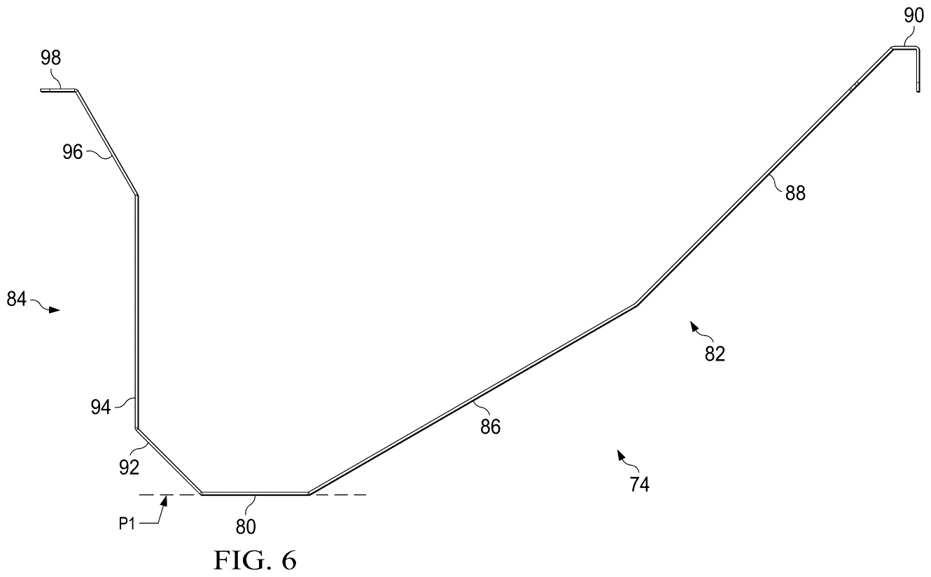

Referring now to FIGS. 5-7, the tray 36 is shown to include a main structure 74, a rear panel 76, and a shroud 78. As illustrated in FIGS. 5 and 6, the main structure 74 can include a floor panel 80, a right side panel 82, and a left side panel 84. The right side panel 82 and the left side panel 84 can be spaced from each other such that the floor panel 80 extends between the right side panel 82 and the left side panel 84 and cooperates with the right side panel 82 and the left side panel 84 to at least partially define the trough 38. The right side panel 82 and the left side panel 84 can extend generally upwardly and can be angled outwardly from the floor panel 80. When chips are introduced onto the main structure 74, the right side panel 82 and the left side panel 84 can encourage the chips into the trough 38 and towards the auger 44. The floor panel 80 can be generally planar and can define a centerline C1 that extends along the floor panel 80. The floor panel 80 and the centerline C1 can reside in an imaginary plane P1. The floor panel 80 can define a plurality of openings 85 that are sized and configured to allow crumbs and other small fragments to fall through the floor panel 80 and/or for the transfer of heat therethrough to keep the chips crispy when the food dispensing machine 20 is equipped with an underlying heating element. In one embodiment, the openings 85 can have a circular cross section and a diameter of about 10 mm. In one embodiment, each of the floor panel 80, the right side panel 82, and the left side panel 84 can be formed together as a one-piece construction, such as, for example, from an individual sheet of material (e.g., stainless steel) that is bent or otherwise shaped into the floor panel 80, the right side panel 82, and the left side panel 84. In another embodiment, the right side panel 82 and the left side panel 84 might be separable from the floor panel 80 and releasably coupled thereto with tabs, fasteners, or any of a variety of suitable alternative releasable coupling arrangements.

The right side panel 82 can include a right lower wall 86, a right upper wall 88, and an end wall 90. The right lower wall 86 can extend between the floor panel 80 and the right upper wall 88 and the right upper wall 88 can extend between the right lower wall 86 and the end wall 90. The right lower wall 86 can be sloped towards the floor panel 80 such that the right lower wall 86 can encourage chips towards the auger 44. The right upper wall 88 can have a more significant (i.e., steeper) slope than the right lower wall 86 such that the right upper wall 88 can encourage the chips towards the right lower wall 86 and further towards the auger 44. In other words, the right lower wall 86 can be angled with respect to the floor panel 80 (i.e., relative to the imaginary plane P1) by a first angle and the right upper wall 88 can be angled with respect to the floor panel 80 (i.e., relative to the imaginary plane P1) by a second angle that is less than the first angle. In one embodiment, the first angle of the right lower wall 86 relative to the floor panel 80 can be about 150 degrees and the second angle of the right upper wall 88 relative to the floor panel 80 can be about 135 degrees.

The left side panel 84 can include a left lower wall 92, a left intermediate wall 94, a left upper wall 96, and an end wall 98. The left lower wall 92 can extend between the floor panel 80 and the left intermediate wall 94, the left intermediate wall 94 can extend between the left lower wall 92 and the left upper wall 96, and the left upper wall 96 can extend between the left intermediate wall 94 and the end wall 98. The left lower wall 92 can be sloped towards the floor panel 80. The left intermediate wall 94 can be substantially vertical (i.e., substantially perpendicular to the floor panel 80) and can thus have a more significant (i.e., steeper) slope than the left lower wall 92. The left upper wall 96 can have a less significant (i.e., shallower) slope than the left intermediate wall 94. In other words, the left lower wall 92 can be angled with respect to the floor panel 80 (i.e., relative to the imaginary plane P1) by a third angle, the left intermediate wall 94 can be angled with respect to the floor panel 80 (i.e., relative to the imaginary plane P1) by a fourth angle that is less than the third angle, and the left upper wall 96 can be angled with respect to the floor panel 80 (i.e., relative to the imaginary plane P1) by a fifth angle that is greater than the fourth angle. In one embodiment, the third angle of the left lower wall 92 can be about 135 degrees, the fourth angle of the left intermediate wall 94 can be about 90 degrees, and the fifth angle of the left upper wall 96 can be about 115 degrees. The left lower wall 92, the left intermediate wall 94, and the left upper wall 96 can accordingly cooperate to encourage the chips towards the auger 44.

The left intermediate wall 94 can be substantially steeper than the right lower wall 86 and the right upper wall 88 (i.e., the first angle is less than the third angle and the fourth angle) such that the main structure 74 is asymmetric about an imaginary plane that is perpendicular to the imaginary plane P1. When chips are introduced onto the tray 36 that covers the auger 44 and the auger 44 rotates in a counterclockwise direction (when viewing the auger 44 from the front of the food dispensing machine 20) to dispense the chips from the tray 36, some of the chips disposed above the auger 44 might be urged towards the left intermediate wall 94. Because the left intermediate wall 94 is so significantly sloped (i.e., vertical and in some cases at an acute angle), the chips that are urged against the left intermediate wall 94 can effectively pile up against the left intermediate wall 94 and thus can be urged back towards to the auger 44 for eventual dispensation therefrom. If the left intermediate wall 94 was not so significantly sloped, but instead had a more gradual slope (e.g., similar to the right upper wall 88), the chips disposed above the auger 44 might be urged away from the auger 44 and potentially lodged on the tray adjacent to the auger 44 thus preventing those chips from being introduced to the auger 44 without human intervention to dislodge them from the tray 36, such as by shaking the food dispensing machine 20 which can potentially damage the food dispensing machine 20 or by accessing the interior chamber 26 and manually disturbing the remaining chips which can be unsanitary. In addition, by providing the right upper wall 88 with a more gradual slope than the left intermediate wall 94, the tray 36 can have a larger volume and can thus hold more chips than if the right upper wall 88 were as steep as the left intermediate wall 94. It is to be appreciated that although the left intermediate wall 94 is described as being substantially perpendicular to the floor panel 80, the left intermediate wall 94 can be provided at any of a variety of angles that are steeper than the first and second angles of the right lower wall 86 and the right upper wall 88 (e.g., between about 90 degrees and 114 degrees) to facilitate urging of the chips back towards the auger 44.

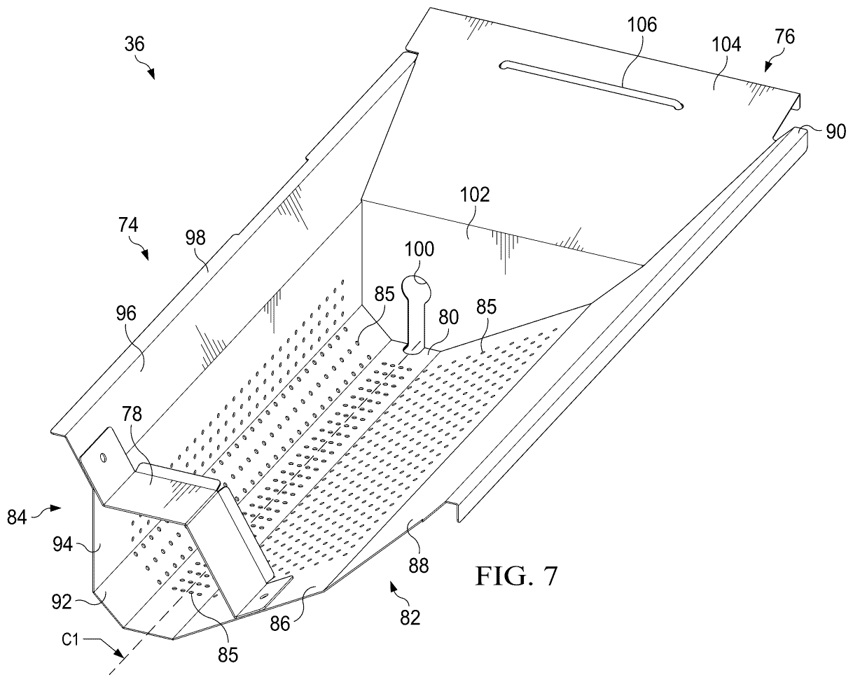

Referring now to FIG. 7, the rear panel 76 can interface with the main structure 74 to define a portion of the trough 38. The rear panel 76 can cooperate with the floor panel 80 to define a slot 100 that is configured to accommodate the threaded driveshaft 60. The rear panel 76 can include a lower wall 102 and an upper wall 104 that extends from the lower wall 102. The upper wall 104 can extend upwardly and outwardly from the main structure 74 and can be sloped towards the trough 38 to facilitate funneling of chips towards the trough 38. In one embodiment, the upper wall 104 can be angled with respect to the lower wall 102 by between about 30 degrees and 60 degrees. The shroud 78 can be coupled with the main structure 74 at the front side 28 of the food dispensing machine 20 and can be routed over a front portion of the helical coil member 54 to facilitate protection thereof. The main structure 74, the rear panel 76, and the shroud 78 can each be formed of stainless steel, a thermoformed material (i.e., plastic), or some combination thereof as well as any of a variety of other suitable alternative materials.

The rear panel 76 can be selectively detachable from the main structure 74. The rear panel 76 can accordingly be removable from the main structure 74 and thus the interior chamber 26 of the housing 22 to gain access to the area adjacent the main structure 74 to facilitate cleaning of the interior chamber 26 and the tray 36. The rear panel 76 can include a handle 106 that can be grasped by a user to facilitate lifting of the rear panel 76 away from the main structure 74. The handle 106 can be selectively retractable between an extended position and a stored position. When the food dispensing machine 20 is in service, the handle 106 can be in the stored position such that the handle 106 rests against the upper wall 104 and away from the chips. When the rear panel 76 is to be detached from the main structure 74, the handle 106 can be grasped and pulled into the extended position to allow a user to more easily grasp the handle 106 to lift the rear panel 76 away from the main structure 74.

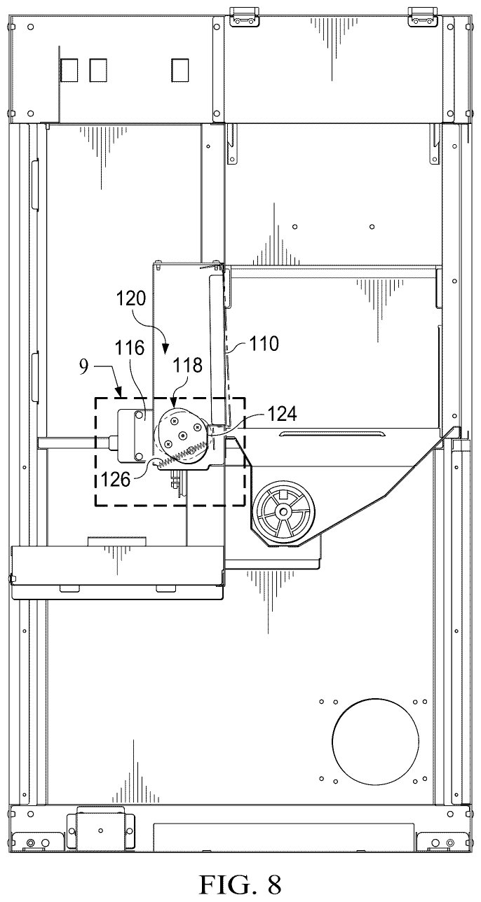

Referring again to FIGS. 1-3, the food dispensing machine 20 can include a chip agitator panel 110 (e.g., an agitator) that is disposed in an interior sidewall 112 adjacent the left side panel 84 of the tray 36. The interior sidewall 112 can at least partially define the interior chamber 26. The chip agitator panel 110 can be pivotally coupled with the interior sidewall 112. Referring now to FIG. 8, the chip agitator panel 110 can be selectively pivoted between a retracted position (shown in solid lines) and an extended position (shown in dashed lines) relative to the left side panel 84 of the tray 36. When in the retracted position, the chip agitator panel 110 can be substantially coplanar with the interior sidewall 112. When in the extended position, a lower portion 114 of the chip agitator panel 110 can be extended away from the interior sidewall 112 and over at least part of the left side panel 84. When the chip agitator panel 110 is pivoted from the retracted position to the extended position, the lower portion 114 can be pivoted outwardly and away from the interior sidewall 112 and into contact with any chips that are piled up on the left side panel 84 to encourage the chips towards the auger 44, as will be described in further detail below.

As illustrated in FIGS. 8-10, a motor 116 can be operably coupled with an agitator cam 118. The motor 116 and the agitator cam 118 can be provided within an interior area 120 that is located behind the chip agitator panel 110. The interior area 120 can be located on an opposite side of the chip agitator panel 110 as the interior chamber 26 such that the motor 116 and the agitator cam 118 are effectively concealed from plain view. The agitator cam 118 can be attached to a drive shaft 119 of the motor 116 that rotates the agitator cam 118 about a rotational axis A2 when the motor 116 is activated. Rotation of the agitator cam 118 about the rotational axis A2 can cause the chip agitator panel 110 to pivot between the retracted position and the extended position.

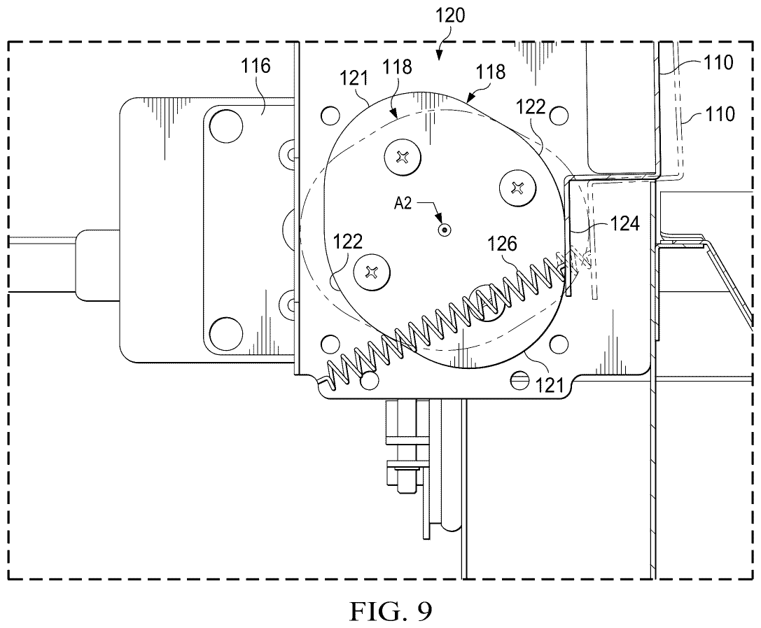

As illustrated in FIG. 9, the agitator cam 118 can include a pair of lobes 121 that are disposed on opposite sides of the agitator cam 118 and a narrow portion 122 that extends between the pair of lobes 121. The diameter of the agitator cam 118 can be wider at the lobes 121 than at the narrow portion 122. The chip agitator panel 110 can include a follower member 124 at the lower portion 114 that extends towards the agitator cam 118 and interfaces with the agitator cam 118 to facilitate pivoting of the chip agitator panel 110 as a function of the rotation of the agitator cam 118 about the rotational axis A2. In particular, when the agitator cam 118 is positioned with one of the narrow portions 122 facing (i.e., contacting) the follower member 124, as shown in solid lines in FIG. 9, the chip agitator panel 110 can be in the retracted position. When the agitator cam 118 is positioned with one of the lobes 121 facing (i.e., contacting) the follower member 124, as shown in dashed lines in FIG. 9, the lobe 121 can push the follower member 124 outwardly which pivots the chip agitator panel 110 into the extended position. A spring 126 can be coupled between the chip agitator panel 110 and the interior sidewall 112 that biases the chip agitator panel 110 towards the retracted position such that when the agitator cam 118 is rotated to move the lobe 121 away from the follower member 124, the chip agitator panel 110 can automatically pivot from the extended position into the retracted position.

In the event that chips become lodged against the left side panel 84 in a manner that might not allow the chips to be introduced to the auger 44, the motor 116 can be selectively activated to rotate the agitator cam 118 through half of a rotation. Such rotation can cause one of the lobes 121 into engagement with the follower member 124 periodically to move the chip agitator panel 110 into the extended position. The lower portion 114 can accordingly be urged against the lodged chips to encourage at least some of the chips towards the auger 44. As the agitator cam 118 continues through the half rotation, one of the narrow portions 122 can ultimately be positioned against the follower member 124 in order to return the chip agitator panel 110 to the retracted position. In one embodiment, the motor 116 can be automatically and periodically activated to move the chip agitator panel 110 between the retracted and extended positions. In another embodiment, the motor 116 can be activated as a function of the detection of chips adjacent to the lower portion 114 of the chip agitator panel 110. In such an embodiment, the lower portion 114 can include a proximity sensor (not shown) that is configured to detect the presence of chips. When the proximity sensor detects chips at the lower portion 114, the motor 116 can be activated (e.g., by a controller) to rotate the agitator cam 118 through half of a rotation. In yet another embodiment, the motor 116 can be manually activated by a user, via a pushbutton, touchscreen, or other similar control device.

It is to be appreciated that although the chip agitator panel 110 is described as being pivotably coupled to the interior sidewall 112, other movable coupling arrangements for the chip agitator panel 110 are contemplated, such as a chip agitator panel that is capable of being selectively telescoped relative to the interior sidewall 112 between the extended and retracted positions. It is also to be appreciated that other suitable alternative agitators are contemplated that might not make use of an agitator panel but that are otherwise movable between a retracted and extended position to disturb a pile of chips, such as a telescoping arm (e.g., solenoid driven or screw driven) or other movable device that is capable of contacting the chips directly. It is further to be appreciated that although a dispensing machine (e.g., 20) for chips is described herein, any of a variety of suitable alternative food dispensing machines for dispensing other ready to eat products besides nacho chips, such as popcorn, peanuts, and candy, for example, are contemplated in accordance with the various principles and features disclosed herein.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Also, for any methods claimed and/or described, regardless of whether the method is described in conjunction with a flow diagram, it should be understood that unless otherwise specified or required by context, any explicit or implicit ordering of steps performed in the execution of a method does not imply that those steps must be performed in the order presented and may be performed in a different order or in parallel.

What is claimed is:

1. A food dispensing machine comprising:
a housing that includes an interior chamber, a dispensation opening, and a sidewall that at least partially defines the interior chamber, the housing defining the dispensation opening;
a tray disposed in the interior chamber and comprising a floor panel and a pair of side panels, the pair of side panels being spaced from each other and cooperating with the floor panel to at least partially define a trough that is disposed adjacent to the dispensation opening;
an auger disposed in the trough and selectively rotatable about a rotational axis; and
an agitator associated with the sidewall adjacent to the tray and movable between an extended position and a retracted position to facilitate selective contact of the agitator with food that is located on the tray.

2. The food dispensing machine of claim 1 wherein the agitator comprises an agitator panel that is pivotably coupled with the sidewall and selectively pivotable between the extended position and the retracted position.

3. The food dispensing machine of claim 2 further comprising a motor and an agitator cam operably coupled with the motor to facilitate selective rotation of the agitator cam, wherein rotation of the agitator cam facilitates pivoting of the agitator panel between the extended position and the retracted position.

4. The food dispensing machine of claim 3 further comprising a biasing member coupled with the sidewall and the agitator panel and configured to bias the agitator panel into the retracted position.

5. The food dispensing machine of claim 3 wherein the agitator cam comprises a pair of lobes and the agitator panel comprises a follower portion that interacts with the lobes to facilitate pivoting of the agitator panel between the extended position and the retracted position.

6. The food dispensing machine of claim 2 wherein the agitator panel is coplanar with the sidewall when in the retracted position.

7. The food dispensing machine of claim 1 wherein:
the pair of side panels comprise a first side panel and a second side panel;
the first side panel comprises a first wall;
the second side panel comprises a second wall; and
the first wall has a more significant slope relative to the floor panel than the second wall.

8. The food dispensing machine of claim 7 wherein:
the floor panel defines a centerline and the centerline and the floor panel reside in an imaginary plane;
the first wall is angled with respect to the imaginary plane by a first angle;
the second wall is angled with respect to the imaginary plane by a second angle; and
the first angle is less than the second angle.

9. A tray for a food dispensing machine, the tray comprising:
a main structure comprising:
a floor panel defining a centerline;
a first side panel extending upwardly and outwardly from the floor panel and comprising a first wall;
a second side panel extending upwardly an outwardly from the floor panel and comprising a second wall, wherein:
the first side panel and the second side panel are spaced from each other and cooperate with the floor panel to define a trough; and
the first wall has a more significant slope relative to the floor panel than the second side panel.

10. The tray of claim 9 wherein:
the floor panel and the centerline reside in an imaginary plane;
the first wall is angled with respect to the imaginary plane by a first angle;
the second wall is angled with respect to the imaginary plane by a second angle; and
the first angle is less than the second angle.

11. The tray of claim 10 wherein the first angle is about 90 degrees and the second angle is about 150 degrees.

12. The tray of claim 10 wherein the first side panel comprises a third wall that is disposed between the floor panel and the first wall and is angled with respect to the imaginary plane by a third angle that is greater than the first angle.

13. The tray of claim 12 wherein the second side panel comprises a fourth wall that is disposed between the floor panel and the second wall and is angled with respect to the imaginary plane by a fourth angle that is greater than the second angle.

14. The tray of claim 13 wherein the first angle is about 90 degrees, the second angle is about 150 degrees, the third angle is about 115 degrees, and the fourth angle is about 135 degrees.

15. The tray of claim 9 wherein the main structure is formed as a unitary one-piece construction.

16. The tray of claim 9 further comprising a rear panel that is releasably attached to the main structure and interfaces with the main structure to further define the trough.

17. A food dispensing machine comprising the tray of claim 9.

18. An auger for a food dispensing machine, the auger comprising:
a helical coil member formed of a wire element that is wound about a central axis, the helical coil member having a length; and
a cross member coupled with the helical coil member at different locations along the length.

19. The auger of claim 18 wherein the cross member is substantially parallel with the central axis.

20. A food dispensing machine comprising the auger of claim 18.
